(19) United States
(12) Patent Application Publication
(10) Pub. No.: US 2002/0040397 A1
(43) Pub. Date: Apr. 4, 2002

(54) IP based network system and networking method thereof

(75) Inventor: Moon-Jeong Choi, Suwon-city (KR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: SAMSUNG ELECTRONICS CO., LTD.

(21) Appl. No.: 09/967,976

(22) Filed: Oct. 2, 2001

(30) Foreign Application Priority Data
Oct. 2, 2000 (KR) 2000-57990

(51) Int. Cl. G06F 15/16

(52) U.S. Cl. 709/226; 709/245

(57) ABSTRACT

An IP based network system, and a communication method in the IP based network system. The IP based network system has a plurality of devices connected with one another, and includes a lookup server for registering information about the plurality of devices, and providing information of a certain device of the plurality of devices upon receipt of request from another device of the plurality of devices that intends to access the certain device. Also included is a DNS server for providing a host name to the plurality of devices of the network system, and a DHCP server for allocating a private IP address to the plurality of devices of the network system. Accordingly, the IP based network system can be established with various devices including not only the intelligent devices but also the dummy devices.

### BACKGROUND OF THE INVENTION

1. Field of the Invention

The present invention relates to a network structure, and more particularly to an IP based network system and a method for communicating in the network system. Korean Patent Application 2000-57990 is incorporated herein by reference.

2. Description of the Related Art

FIG. 1 is a diagram illustrating a structure of a general home network.

Generally, home appliances include an information device such as personal computers, facsimile machines, scanners and printers, an A/V device such as TVs, set-top boxes, DVDs, VCRs, audio components, camcorders and household game machines, a control device such as coffee makers, electric cookers, refrigerators, washing machines, microwave ovens and cameras, and a dummy device such as remote controllers, interphones, sensors and lamps.

As shown in FIG. 1, the home appliances are connected within a home network by USB, IEEE1394, a telephone line, a power line, a wireless LAN and a Bluetooth. Since the devices within a home network establish a plurality of different sub-networks, and the devices operate on different hardware and software platforms, it is quite difficult to construct a home network. In order to construct a home network under these circumstances, it is suggested that a virtual computing environment called a “middleware” is built for the home appliances and applications are provided thereon.

FIG. 2 is a view illustrating a protocol stack of a home network using a middleware. The middleware is software for communications among different kinds of devices and enables diverse devices to communicate with one another. The middleware is positioned between an operating system and an application program, and transparently connects dispersed applications and data under a client server environment.

More specifically, the middleware independently connects hardware along the network to assist a variety of communication protocols, system structures, operating system OS, databases and application programs.

Currently available middleware includes, for example, UpnP (Universal Plug and Play), HAVi (Home AV Interoperability), JINI, Home Wide Web, etc. Among these, HAVi uses a separate protocol stack design based on IEEE1394, but it is insufficient for internetworking.

Also, UpnP and JINI, which use a TCP/IP protocol for internetworking as well as for networking between PCs and peripheral devices of the PCs, are also insufficient for transmission of real time data, namely, audio/video data between digital home appliances.

With the TCP/IP technology, products in the house can be analyzed and, thus, controlled easily via the Internet at any time, even when the users are out of the home network. However, most of the time, there are not separate managers to manage home networks, and users of home networks don't have sufficient knowledge. Accordingly, a home network that is easy to use is required.

### SUMMARY OF THE INVENTION

The present invention has been made to overcome the abovementioned problems of the related art, and accordingly, it is an object of the present invention to provide an Internet Protocol (IP) based network system which enables easy access to various devices of the network, including dummy devices as well as intelligent devices, thus enabling an access to the devices in the network via the Internet, anytime and anywhere.

Another object of the present invention is to provide a method for communicating in the IP based network system, including intelligent devices and even dummy devices, enabling a local networking inside the network and an inter-networking among various networks.

The above object is accomplished by an IP based network system having a plurality of devices, which are connected with one another according to the present invention, including a lookup server for registering information about the plurality of devices, and providing information of a certain device of the plurality of devices upon receipt of a request from another device of the plurality of devices that intends to access the certain device; a Domain Name System (DNS) server for providing a host name to the plurality of devices of the network system; and a Dynamic Host Configuration Protocol (DHCP) server for allocating a private IP address to the plurality of devices of the network system.

Another object of the invention is accomplished by an IP based network system having a plurality of devices connected with one another. The network includes means for registering information about the plurality of devices, wherein when a first device of the plurality of devices requests information about a second device of the plurality of devices which the first device intends to access, the means for registering information provides information about the second device upon receipt of the request from the first device. The network further includes means for providing a host name to the plurality of devices of the network system; and means for allocating a private IP address to the plurality of devices of the network system.

A further object is accomplished by a method for communicating in an IP based network system having a plurality of devices connected with one another, and a lookup server for managing the plurality of devices according to the present invention, including the steps of i) the lookup server, being provided with and registering information about the plurality of devices, ii) one of the plurality of devices, requesting lookup server information about another device, of the plurality of devices, that the one device intends to access, and iii) the one device, accessing the another device by using the information about the another device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which alike reference symbols indicate the same or similar components, wherein:

FIG. 1 is a diagram illustrating a structure of a home network in general;

FIG. 2 is a table illustrating a protocol stack of a home network using a middleware;

FIG. 3 is a diagram illustrating a structure of a home network according to the present invention;

FIG. 4 is a diagram illustrating an initializing process of a home network;

FIG. 5 is a diagram illustrating a local networking;

FIG. 6 is a diagram illustrating a release process of a server;

FIG. 7 is a diagram illustrating a packet conversion in an outgoing networking;

FIG. 8 is a diagram illustrating a flow of signal according to an incoming networking method; and

FIG. 9 is a diagram illustrating a packet conversion in the incoming networking.

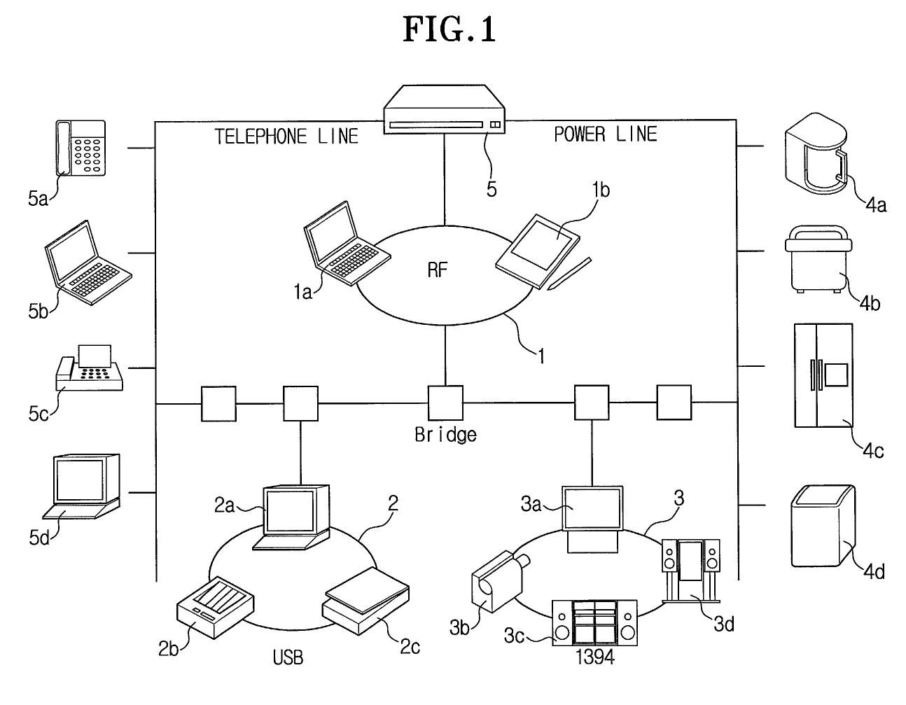

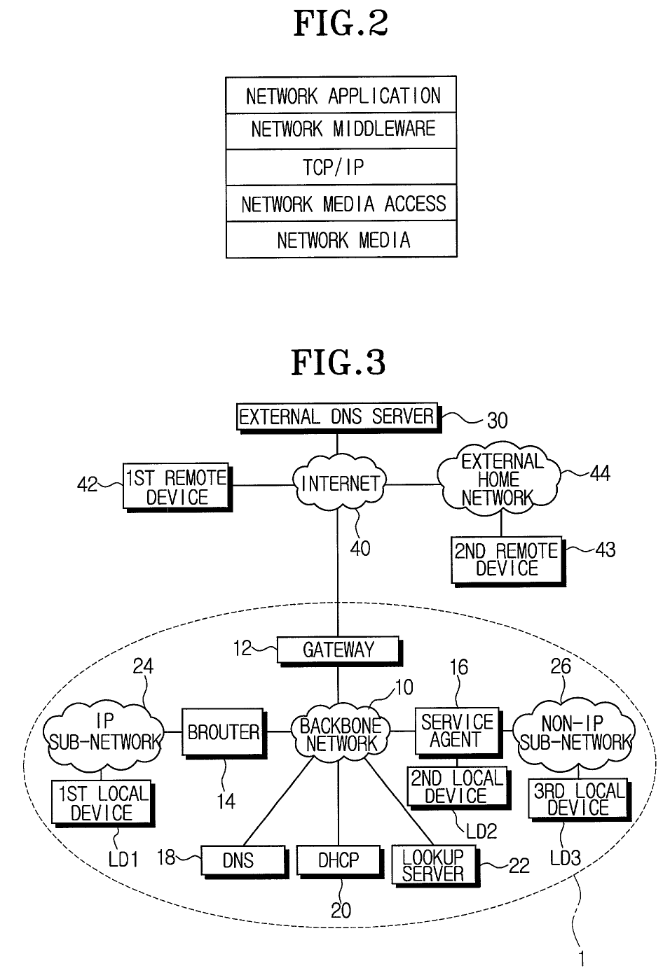

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

FIG. 3 is a diagram illustrating a structure of a home network according to the present invention. A home network 1 includes an IP backbone network 10, a gateway 12, a brouter 14, a service agent 16, a DNS service server 18, a DHCP service server 20, a lookup server 22, an IP sub-network 24, a non-IP server network 26, and local devices LD1, LD2, LD3. Outside of the home network 1, there are provided a first remote device 42 for accessing a home network, an external DNS service server 30, the Internet 40, an external home network 44, and a second remote device 43 connected to the external home network 44.

The construction of the home network will be described below.

The gateway 12 is an entry node enabling the home network 1 to communicate with external networks through the Internet and other home networks. Therefore, a translation is performed in the gateway 12 between a private IP address assigned to devices of the home network 1 and a public IP address used in an external network.

Also, the intelligent devices within the home network 1 are connected to the IP sub-network 24, while the non-intelligent devices such as dummy devices are connected to the non-IP sub-network 26. The dummy devices, such as lamps, automatic doors and washing machines, cannot control themselves but simply perform specified functions.

The basic protocol inside the home network uses TCP/IP. All the nodes within the home network are distinguished by IP addresses so as to designate a particular node under an environment where a plurality of nodes are connected through the network.

A DNS server 18 provides a host name for the devices within the home network 1. Meanwhile, the host name can either be a default name, which is provided in advance to represent a function of the device, or a name made by a user. Where identical default names exist, extension numbers are added for distinguishing one from another. The host name is used when requesting a DHCP server 20 to assign a private IP address of the device.

The DHCP server 20 provides the devices within the home network 1 with unique identifiers (i.e., IP addresses). The brouter, a bridge and a router, is positioned between an IP backbone network 1 and an IP sub-network 24 to find a path of an IP packet transmitted between the IP backbone network 1 and the IP sub-network 24.

The service agent 16 positioned between the non-IP sub-network 26 and the IP backbone network 10 converts services on an application level to deliver to the non-IP node the services that use IP networking. For the devices that do not have support for TCP/IP (hereinafter, called “non-IP devices”) in the non-IP sub-network 26, the service agent 16 causes the private IP addresses to be assigned to the non-IP devices from the DHCP server 20 and thus allows the non-IP devices to be connected to the home network.

The service agent 16 also grasps the status of the non-IP nodes. In other words, the service agent 16 manages information about the status of the non-IP nodes, such as whether the non-IP node has power on, or the non-IP node is inserted in the home network, or the like. Further, the service agent 16 manages private IP addresses assigned to the non-IP devices, and also, the service agent 16 manages information about the relations between the private IP addresses and hardware addresses of the non-IP devices.

A device requesting an access for service to other devices is defined as a service client, while the device providing such requested service is defined as a service server. The service server waits for the access request from the service client, opening its access point, and gives an access to the service client upon receipt of the access request.

The device in the home network can either be the service client or the service server depending on whether the device makes request for service or provides requested service. As described, according to the operation status of the devices in the home network, the devices are defined as the service client or the service server.

For example, if a certain device accesses the DHCP server and requests an allocation of an IP address for the device, the requesting device becomes the service client, while the DHCP server becomes the service server. Otherwise, i.e., if the certain device provides the service requested by another device, the certain device becomes the service server.

An interface of the service server and the client includes a direct interface and an indirect interface. The direct interface is that the service server and the client provide and receive a data unit through an IP networking path, while the indirect interface is that the service server is a non-IP node, and the service server and the client provide and receive the data unit through a service agent.

The lookup server 22 manages and provides registration information about the devices within the home network 1. Since the IP addresses allocated to the devices of the home network 1 are managed by the lookup server 22, all the internal nodes of the home network 1 can exchange information with one another regardless of the network media interface. Further, the lookup server 22 registers a URL of the home network 1 and a global IP address that are allocated to the home network 1 in an external DNS server 30, thereby enabling a communication of the home network 1 with external devices or networks.

Next, the external devices and networks of the home network 1 will be described. Since the external DNS server 30 stores the URL of the home network 1 and the global IP address of the home network 1 that are registered by and received from the lookup server 22 of the home network 1, the external devices or network can access the home network 1.

An access method for the network according to the present invention will be described below.

According to the present invention, there are two types of networking. One is a local networking in which the device of the home network 1 communicates with another device of the home network 1. The other networking is an inter-networking in which the device of the home network 1 communicates with a device of an external network.

Further, the inter-networking includes an outgoing networking in which the device of the home network accesses a certain node of an external network, and an incoming networking in which a certain node of an external network accesses a device of the home network 1. First, the local networking, i.e., the networking in which the device of the home network 1 accesses another device of the home network 1, will be described with reference to accompanying drawings. When the power is on, the devices of the home network 1 perform initialization to establish a network for communication with one another.

The items required for the network establishment include an IP address of a node, a host name of the node, a sub-network mask used by the node, a default gateway address used by the node, and a DNS server address used by the node.

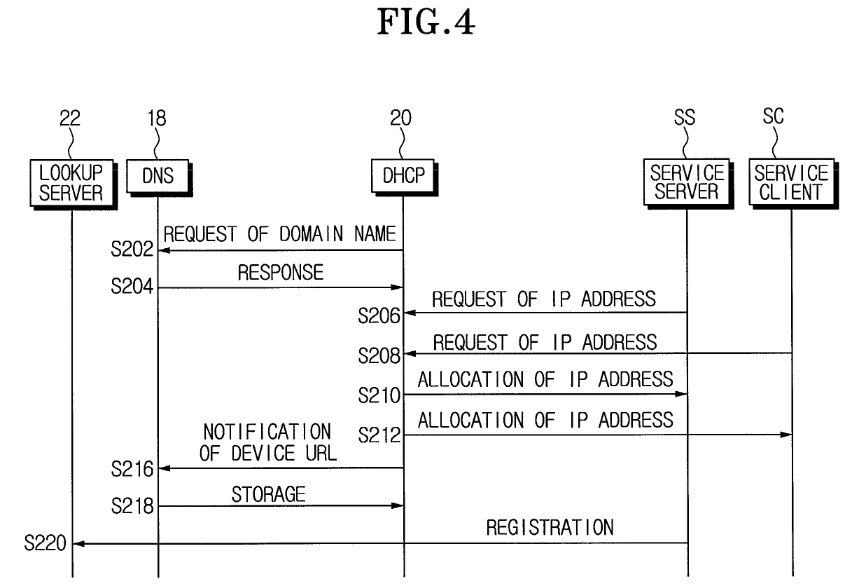

FIG. 4 is a diagram illustrating an initialization of the home network.

In order to obtain private IP addresses for the nodes, the DHCP server 20 requests a domain name from the DNS server 18 (step S202), and the DNS server 18 gives the domain name to the DHCP server 20 as a response (step S204). Then, the service server (SS) and the service client (SC) of the home network 1 request IP addresses from the DHCP server 20 (steps S206 and S208), and the DHCP server allocates the IP addresses to the service server (SS) and the service client (SC), respectively (steps S210 and S212). At this time, for the non-IP devices connected in the non-IP sub-nets, the service agent 16 requests the IP addresses to the DHCP server 20.

The DHCP server 20 notifies the domain name and the IP address of the device to the DNS server 18 (step S216), and the DNS server 18 stores such notified domain name and the IP address of the device (step S218). The service server (SS) registers device information such as a device type, vendor, model name, serial number, etc. in the lookup server 22, and also its information such as an assigned IP address and URL, etc (step S220).

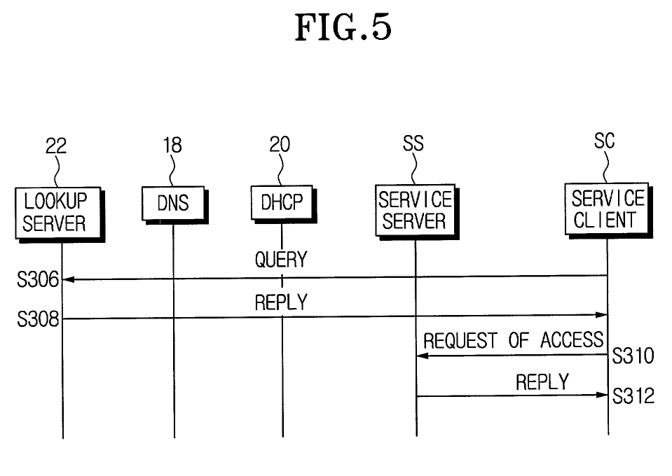

FIG. 5 is a diagram illustrating a local networking. In the initialized home network 1, as the service client (SC) sends the lookup server 22 a query for an access to the service server (SS) (step S306), the lookup server 22 sends out the information that is stored therein about the service server (SS) (step S308). Such sent information contains the IP address of the service server (SS). Then by using such transmitted IP address, the service client (SC) requests the service server (SS) for the access (step S310), and the service server (SS) sends a response to the service client (SC) (step S312). Meanwhile, since the service agent 16 manages the status information and private IP addresses of the non-IP devices to connect devices, which do not support for TCP/IP, to the home network 1, the service agent 16 is always defined as the service server (SS) when the service client (SC) requests an access to the non-IP nodes.

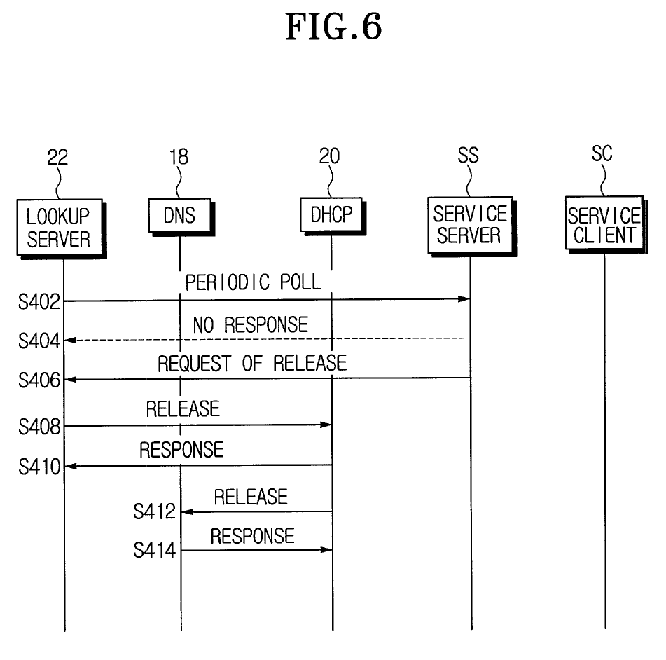

FIG. 6 is a diagram illustrating a releasing process of the service server. The lookup server 22 periodically sends a polling signal to the service server (SS) to check the status of the service server (SS) (step S402). If no response signal is received from the service server (SS) (step S404), the lookup server 22 carries out a registration release process.

The registration release process is also carried out when the service server (SS) requests the lookup server 22 to release the registration (step S406). The lookup server 22 asks the DHCP server 20 to release allocation of the IP address (step S408), and the DHCP server 20 releases the allocation of the IP address (step S410). Further, the DHCP server 20 asks for the release of information that is registered in the DNS server 18 (step S412), and the DNS server 18 gives a response to the release request of the DHCP server 20 (step S414).

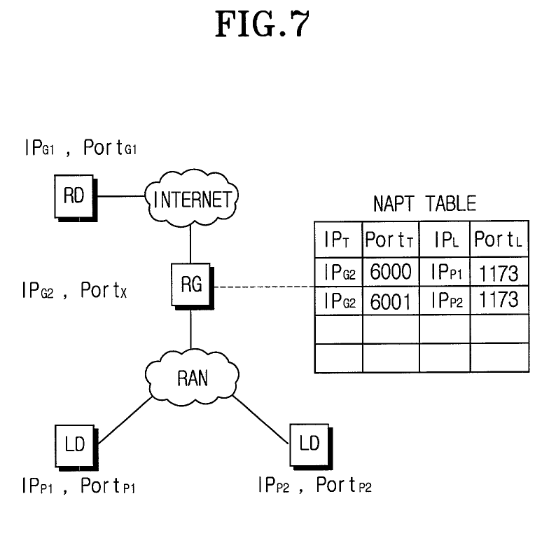

The inter-networking will be described with reference to the initialization, local networking process, and registration release process. First, the outgoing networking will be described with reference to FIG. 7.

FIG. 7 is a diagram illustrating a packet conversion in the outgoing networking. Through the previously-described initialization process, the devices of the home network 1 are allocated with the private IP addresses, respectively. Here, since the packet using the private IP address cannot be transmitted through the Internet, there is a need for a method for sharing a global IP address with the home network 1.

Such global IP address sharing method uses a Network Address Port Translation Protocol (NAPT protocol). According to the NAPT protocol, in order for an internal device to access an external device of the network, a packet is sent out after internal and external port values are allocated at an entry node of the network. Upon receipt of a response packet, the original IP address and the port values are recovered based on the port values contained in the response packet. Since the NAPT protocol is well-known in the field, the further description thereof will be omitted.

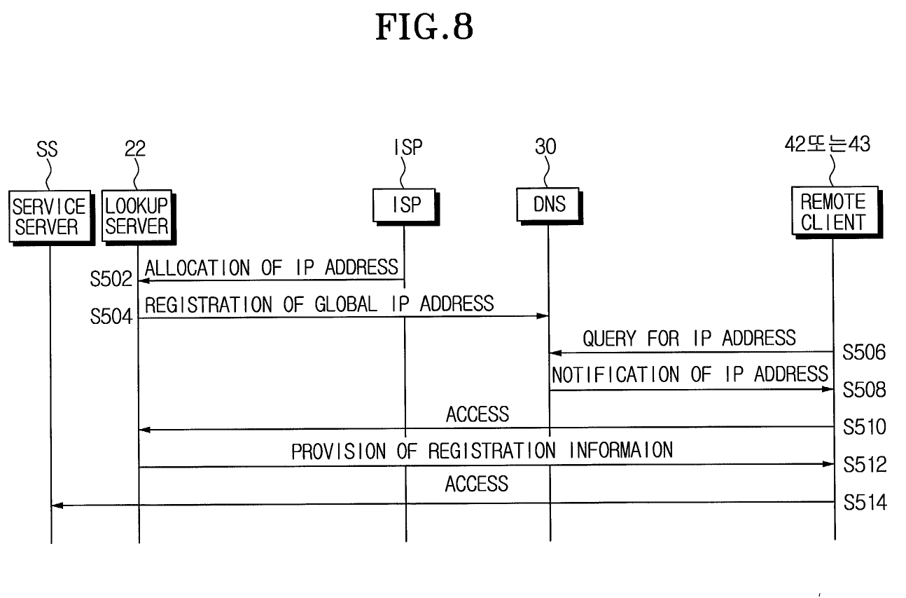

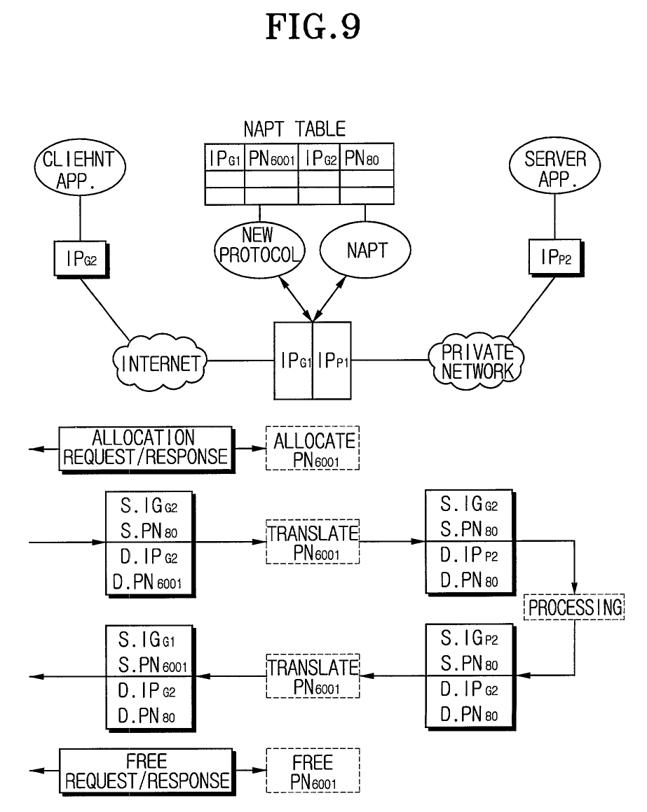

Next, the incoming networking will be described with reference to FIGS. 8 and 9. FIG. 8 is a diagram illustrating a flow of signal according to the incoming networking method, and FIG. 9 is a diagram illustrating a packet conversion of the incoming networking.

When the home network 1 is allocated with an IP address through the server such as an ISP that provides an access to the Internet (step S502), the lookup server 22 of the home network 1 registers the URL of the home network 1 and the global IP address that is currently allocated to the home network 1 (step S504).

Accordingly, when the external remote devices, i.e., when the remote client 42 or 43 requests from the DNS server 30, the global IP address of the home network 1 (step S506), the external DNS server 30 notifies the global IP address of the home network 1 (step S508). The remote client 42 or 43 accesses the lookup server 22 of the home network 1, by using the global IP address of the home network 1 (step S510). Then, the lookup server 22 provides the currently registered information about the devices of the home network 1 (step S512). The provided information contains the private IP addresses of the devices of the home network 1.

By using the information provided by the lookup server 22, the remote client 42 or 43 accesses its intended device (step S514). Accordingly, in the network structure according to the present invention, both local and internetworking is achieved.

As described above, by the IP based network system and communicating method thereof according to the present invention, an IP based network can be established with various devices such as intelligent devices and even the dummy devices. Further, according to the present invention, an access to the device of the network is enabled via the Internet anytime and anywhere. Even further, not only the local networking, but also the internetworking with external devices or external networks is achieved.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An Internet Protocol (IP) based network system having a plurality of devices connected with one another, comprising:
a lookup server which registers information about the plurality of devices, wherein when a first device of the plurality of devices requests information about a second device of the plurality of devices which the first device intends to access, the lookup server provides information about the second device upon receipt of the request from the first device;
a Domain Name System (DNS) server which provides a host name to the plurality of devices of the network system; and
a Dynamic Host Configuration Protocol (DHCP) server which allocates a private IP address to the plurality of devices of the network system.

2. The network system of claim 1, wherein the information about the second device contains an IP address.

3. The network system of claim 1, wherein at least one of the devices is a dummy device, and the network system further comprises a service agent which manages the dummy devices.

4. The network system of claim 3, wherein the service agent requests the DHCP server to allocate private IP addresses to the dummy devices.

5. The network system of claim 1, wherein the lookup server registers an IP address of the network system in an external DNS server existing outside the network system, so that the external DNS server provides the IP address of the network system when an external network intends to access an internal node of the network system.

6. The network system of claim 1, wherein a Network Address Port Translation (NAPT) protocol is used when one of the plurality of devices of the network system intends to access a node of an external network.

7. The network system of claim 5, wherein the external network is the Internet.

8. A method for communicating in an Internet Protocol (IP) based network system having a plurality of devices connected with one another, and a lookup server for managing the plurality of devices, the method comprising the steps of:
i) registering information about the plurality of devices provided from the devices using the lookup server;
ii) requesting information from the lookup server, by a first one of the plurality of devices, about a second device of the plurality of devices, the first device intends to access; and
iii) accessing the second device, by the first device, by using the information about the second device.

9. The communication method of claim 8, wherein the information about the second device contains an IP address of the second device.

10. The communication method of claim 8, further comprising the steps of:
periodically sending out, by the lookup server, a polling signal to check status of the registered devices; and
releasing the registration information when there is no response to the polling signal.

11. The communication method of claim 8, further comprising accessing the second device by the first device when the second device is a dummy device through the use of a service agent for managing dummy devices.

12. The communication method of claim 8, further comprising the steps of:
a) registering a global IP address in an external Domain Name System (DNS) server when the network system is allocated with the global IP address through a server which provides an access to the Internet;
b) requesting from the external DNS server, by remote devices existing outside the network, an IP address of the network system;
c) providing the IP address of the network system by the external DNS server; and
d) accessing the network system by using the IP address of the network system.

13. The communication method of claim 12, wherein the step d) further comprises the steps of:
providing registered information about a plurality of devices of the network system; and
accessing, by the remote devices, an intended device of the network system by using at least a part of the information provided about the plurality of devices of the network system.

14. The communication method of claim 13, wherein the information about the plurality of devices of the network contains a private IP address of the plurality of devices.
